(19) United States
(12) Patent Application Publication
(10) Pub. No.: US 2016/0072764 A1
(43) Pub. Date: Mar. 10, 2016

(54) DYNAMIC DOUBLE NETWORK ADDRESS TRANSLATOR

(71) Applicant: T-Mobile USA, Inc., Bellevue, WA (US)

(72) Inventor: Sergey Arshinov, Bellevue, WA (US)

(21) Appl. No.: 14/483,084

(22) Filed: Sep. 10, 2014

(51) Int. Cl. H04L 29/12

(52) U.S. Cl. CPC H04L 61/2503; H04L 61/1511

(57) ABSTRACT

Systems and methods for network address translations are provided, which include a dynamic double network address translation (NAT) solution for interconnecting overlapping IP networks. Some embodiments allow efficient automated connectivity between two networks with overlapping IP address ranges based on the DNS resolutions. As a result, manual identification and configuration of static translations for specific data flows between networks can be eliminated.

### BACKGROUND

Internet Protocol version 4 (IPv4) uses 32-bit addresses. As a result, the address space for IPv4 is limited to just under 4.3 billion addresses. Of the approximately 4.3 billion addresses, IPv4 also reserves a small number of various address blocks for a variety of reasons. For example, three ranges of addresses are reserved for use in private networks (i.e., 10.0.0.0-10.255.255.255, 172.16.0.0-172.31.255.255, and 192.168.0.0-192.168.255.255) which are not routable outside of the private networks. However, with the proliferation of computing devices throughout the world, the number of available IP addresses available through IPv4 is insufficient.

To address this problem of an insufficient number of IP addresses, in the late 1990's, IPv6 was created which uses 128-bit addresses. However, the conversion of network components, software, and computing devices is still incomplete. As a result, many workarounds to connect computing devices throughout the world are needed until the conversion is complete.

### BRIEF DESCRIPTION OF THE DRAWINGS

Embodiments of the present invention will be described and explained through the use of the accompanying drawings in which:

FIG. 1 illustrates an example of a communications environment in which some embodiments of the present invention may be utilized;

FIG. 2 is a block diagram illustrating various components routing communications between two clients within different private networks in accordance with some embodiments of the present invention;

FIG. 3 illustrates various components that can be used to create a translation device in accordance with various embodiments of the present invention;

FIG. 4 is a high-level flowchart illustrating a set of operations for routing messages in accordance with one or more embodiments of the present invention;

FIG. 5 is a flowchart illustrating a set of operations for operating a translation device in accordance with some embodiments of the present invention;

FIG. 6 is a flowchart illustrating a set of operations for routing a message in a networked environment in accordance with at least one embodiment of the present invention;

FIG. 7 is a sequence diagram illustrating communications between various components within a network; and

FIG. 8 illustrates an example of a computer system with which some embodiments of the present invention may be utilized.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

Many private networks use network address translation (“NAT”) to allow a private network (e.g., a home or office network) having multiple computing devices with private IP addresses to exist behind one or more public IP addresses. The private IP addresses cannot be used outside of the private network. This may be for security reasons or because the private IP addresses are not routable outside of the private network. As a result, the public IP addresses are used for communication with external networks, while communication within the private network use the private IP addresses assigned to the computing devices. For example, when a computing device using a private IP address communicates with the external world, the private address identified in a communication packet is translated to the public IP address using NAT.

Various embodiments of the present invention generally relate to a dynamic double NAT solution for interconnecting overlapping IP networks. For example, some embodiments of the dynamic double NAT solution can be used to merge or build communication channels between two companies using identical address space. Some embodiments allow for efficient automated connectivity between two networks with overlapping IP address ranges based on the DNS resolutions. As a result, manual identification and configuration of static translations for specific data flows between networks can be eliminated.

In the following description, for the purposes of explanation, numerous specific details are set forth in order to provide a thorough understanding of embodiments of the present invention. It will be apparent, however, to one skilled in the art that embodiments of the present invention may be practiced without some of these specific details.

Moreover, the techniques introduced here can be embodied as special-purpose hardware (e.g., circuitry), as programmable circuitry appropriately programmed with software and/or firmware, or as a combination of special-purpose and programmable circuitry. Hence, embodiments may include a machine-readable medium having stored thereon instructions that may be used to program a computer (or other electronic devices) to perform a process. The machine-readable medium may include, but is not limited to, floppy diskettes, optical disks, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other types of media/machine-readable mediums suitable for storing electronic instructions.

### Terminology

Brief definitions of terms, abbreviations, and phrases used throughout this application are given below.

The phrases “in some embodiments,” “according to some embodiments,” “in the embodiments shown,” “in other embodiments,” and the like generally mean the particular feature, structure, or characteristic following the phrase is included in at least one implementation of the present invention, and may be included in more than one implementation. In addition, such phrases do not necessarily refer to the same embodiments or different embodiments.

The term “module” refers broadly to general or specific-purpose hardware, software, or firmware (or any combination thereof) components. Modules are typically functional components that can generate useful data or other output using specified input(s). A module may or may not be self-contained. Depending upon implementation-specific or other considerations, the modules may be centralized or functionally distributed. An application program (also called an “application”) may include one or more modules, or a module can include one or more application programs.

### General Description

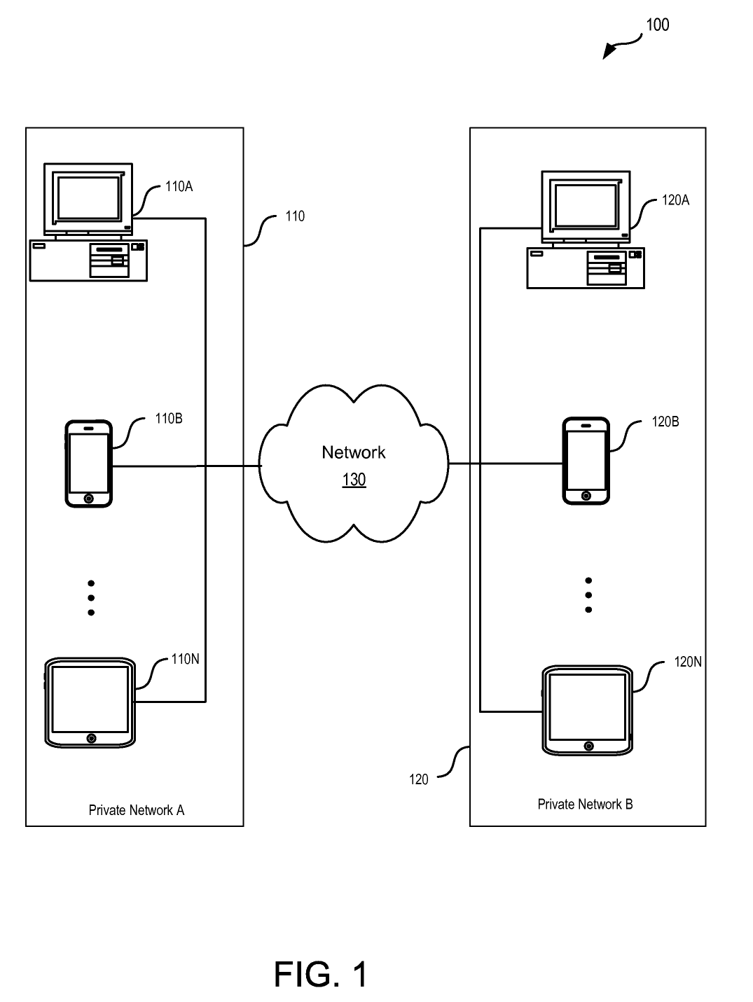

FIG. 1 illustrates an example of a network-based environment in which some embodiments of the present invention may be utilized. The embodiments illustrated in FIG. 1 show private networks 110 and 120 with multiple computing devices 110A-110N and 120A-120N respectively. Computing devices 110A-110N and 120A-120N can be any computing device capable of receiving user input as well as transmitting and/or receiving data via network 130.

In one embodiment, computing devices in private network 110 and/or 120 may include conventional computer systems (e.g., a desktop or laptop computer), a tablet computer, or a mobile device having computer functionality (e.g., a mobile telephone or a smart-phone). Computing devices 110A-110N and 120A-120N may also include various networking devices such as, but not limited to, routers, gateways, servers, and other components capable of generating IP traffic to communicate with other components. In some embodiments, computing devices 110A-110N and 120A-120N can retrieve or submit information to other computing devices and run one or more applications for interacting with a user. For example, computing devices 110A-110N and 120A-120N may be capable of executing a browser application or a customized client to enable interaction between the computing devices.

Network 130 can include any combination of networks, such as local area and/or wide area networks using both wired and wireless communication systems. In one embodiment, network 130 uses standard communication technologies and/or protocols. Thus, network 130 may include links using technologies such as Ethernet, 802.11, worldwide interoperability for microwave access (WiMAX), 3G, 4G, CDMA, digital subscriber line (DSL), etc. Similarly, the networking protocols used on network 130 may include multiprotocol label switching (MPLS), transmission control protocol/Internet protocol (TCP/IP), User Datagram Protocol (UDP), hypertext transport protocol (HTTP), simple mail transfer protocol (SMTP) and file transfer protocol (FTP). Data exchanged over network 130 may be represented using technologies and/or formats including hypertext markup language (HTML) or extensible markup language (XML). In addition, all or some links can be encrypted using conventional encryption technologies such as secure sockets layer (SSL), transport layer security (TLS), and Internet Protocol security (IPsec).

Private networks 110 and 120 may use known addresses, such as the three ranges of addresses that are reserved for use in private networks (i.e., 10.0.0.0-10.255.255.255, 172.16.0.0-172.31.255.255, and 192.168.0.0-192.168.255.255). These private network IP ranges are not routable outside of the private networks. As such, many private networks utilize the same IP ranges. Thus, different computing devices may be assigned the same private IP address. For example, computing device 110A and 120A may both be assigned to 10.0.1.1. The assignment of the same IP address to multiple computing devices creates a problem when merging private networks. As a result, a solution is needed to masquerade the duplicated addresses.

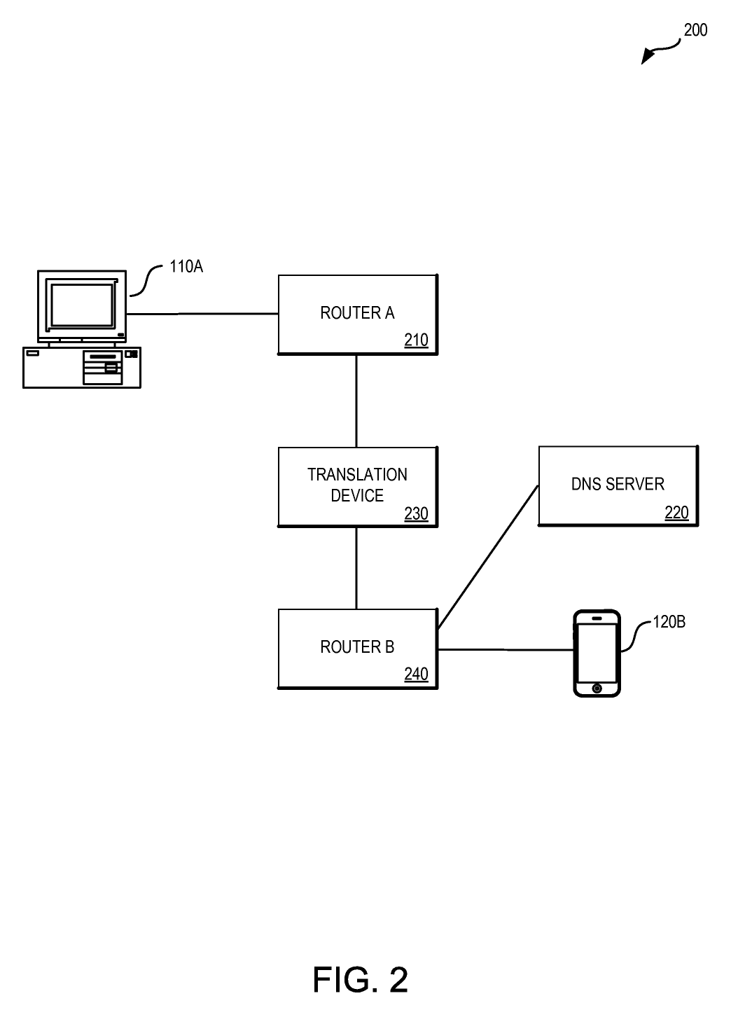

FIG. 2 is a block diagram illustrating various components 200 routing communications between two clients within different private networks that have been merged or are to otherwise communicate in accordance with some embodiments of the present invention. Computing device 110A and 120B may both have been assigned an identical private IP address (e.g., 10.0.1.1). Computing device 110A in private network A desires to communicate with computing device 120B in private network B. The computing device 110A makes a DNS query using the Fully Qualified Domain Name (FQDN) for the IP address of the computing device 120B. Since DNS server 220 has its own public IP address, the IP address of DNS server 220 will not overlap any of the computing devices in the private networks. As a result, computing device 110A can easily communicate with DNS server 220.

DNS server 220 receives this query and retrieves the local IP address of computing device 120B. The reply transaction is then routed through translation device 230. In accordance with various embodiments, translation device 230 can be a separate hardware network element, or functionality residing in existing elements, like in the DNS server, a router/bridge, server, etc. Translation device 230 creates a dynamic entry in a transaction table or other data structure that relates to internal private IP address of computing device 120B with a temporary inter-zone IP address selected (e.g., by translation device 230) from a group of IP addresses assigned to private network B. After that translation device modifies the reply transaction to include the temporary IP address assigned by translation device 230 and is forwarded on to the computing device 110A. As a result, computing device 110A will not have that internal private IP address assigned to computing device 120B, but will have the inter-zone IP address B assigned by the translation device.

Similarly, when computing device 110A sends a message to the temporary IP address assigned by the network translator to computing device 120B, translation device 230 assigns a temporary inter-zone IP address selected from a group of IP addresses assigned to private network A. The message is then modified and passed on to computing device 120B using router B 240. The response from computing device 120B is modified twice using translation table entries created to allow for routing back to computing device 110A. As a result, translation device 230 uses a dynamic double NAT solution for interconnecting and overlapping IP networks. The following table illustrates the an example of the communications between the network components and their modification by translation device 230:

| | | | | After |
|---|---|---|---|---|
| From Computing | At Translation | From DNS | At Translation | Translation |
| Device 110A | Device 230 | Server | Device 230 | Device 230 |
| Source IP | Source IP | Source IP | Source IP | Source IP |
| 10.0.1.1 | 100.64.1.1:23456 | 198.51.100.1 | 198.51.100.1 | 198.51.100.1 |
| Dest IP | Dest IP | Dest IP | Dest IP | Dest IP |
| 198.51.100.1 | 198.51.100.1 | 100.64.1.1:23456 | 100.64.1.1:23456 | 10.0.1.1 |
| DNS Query | DNS Query | DNS Response | DNS Response | DNS Response |
| S1.privatenetwork | S1.privatenetwork | 10.0.0.1 | 100.64.2.1:34567 | 100.64.2.1:34567 |
| B.com | B.com | | | |

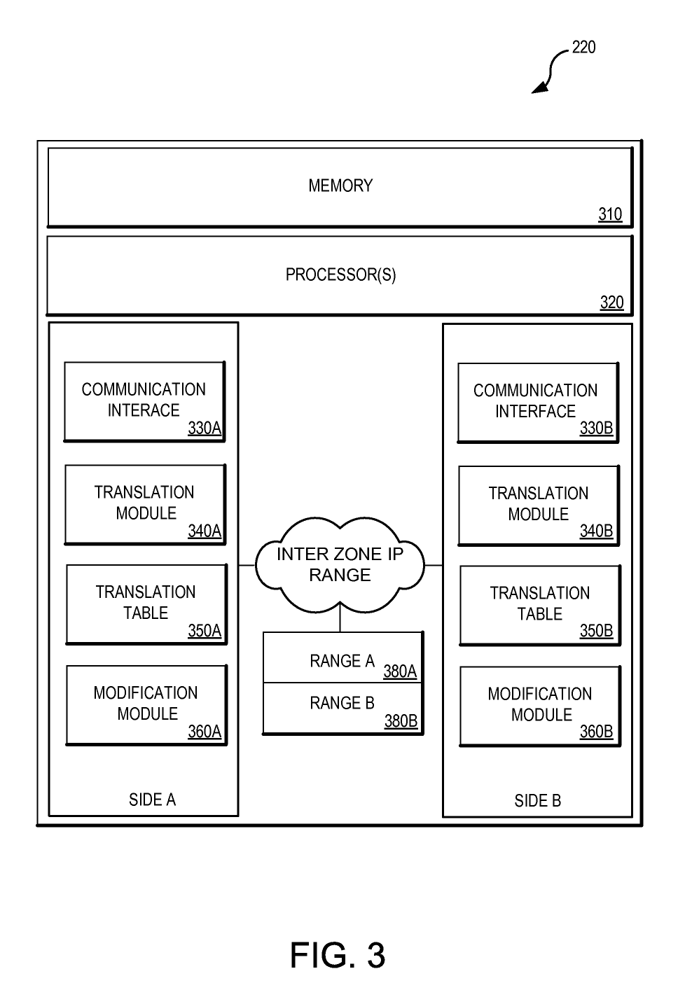

FIG. 3 illustrates various components that can be used to create a translation device 230 in accordance with various embodiments of the present invention. According to the embodiments shown in FIG. 3, translation device 230 can include memory 310, one or more processors 320, a first side and a second side each having a communications interface 330A and 330B, translation module 340A and 340B, translation table 350A and 350B, and modification module 360A and 360B. Other embodiments of the present invention may include some, all, or none of these modules and components along with other modules, applications, and/or components. For example, some embodiments of translation device 230 may include a graphical user interface generation module (not shown) to allow for inter-zone IP ranges to be assigned to range A 380A and range B 380B. Still yet, some embodiments may incorporate two or more of these modules and components into a single module and/or associate a portion of the functionality of one or more of these modules with a different module.

Memory 310 can be any device, mechanism, or populated data structure used for storing information. In accordance with some embodiments of the present invention, memory 310 can encompass any type of, but is not limited to, volatile memory, nonvolatile memory and dynamic memory. For example, memory 310 can be any memory noted herein. In accordance with some embodiments, memory 310 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information which can be used as memory 310.

Memory 310 may be used to store instructions for running one or more applications or modules on processor(s) 320. For example, memory 310 could be used in one or more embodiments to house all or some of the instructions needed to execute the functionality of communications interface 330A and 330B, translation module 340A and 340B, translation table 350A and 350B, and/or modification module 360A and 360B.

Communications interfaces 330A and 330B may be any component designed to receive and transmit IP traffic. These interfaces may be assigned different IP addresses (e.g., side A: 100.64.1.x/24 and side B: 100.64.2.x/24) thereby allowing various network components (e.g., DNS servers, routers, etc.) to direct traffic directly to side A or side B of network translation device 230.

In response to a DNS server, translation modules 340A and 340B can be used to temporarily assign inter-zone IP addresses from range A 380A or range B 380B. These assignments can be stored in respective translation tables 350A or 350B. Then, any packet routable to one of the private networks (i.e., private network A or private network B) can be modified using modification module 360A and/or 360B so that the packet is pointed to the appropriate computing device within one of the private networks. Modification modules 360A and/or 360B may also update the translation table by removing temporary inter-zone IP address assignments and ports. For example, in some embodiments, after a fixed period of time after the translation has the time to be transmitted to the next hop, modification module 360A or 360B can update the translation table by removing the entry. While FIG. 3 illustrates two sides for ease in understanding, in some embodiments, the functionality of both sides may be combined into a single device concurrently performing the functionality of both sides using, e.g., a multi-threaded architecture, a multiprocessor environment, or other configuration.

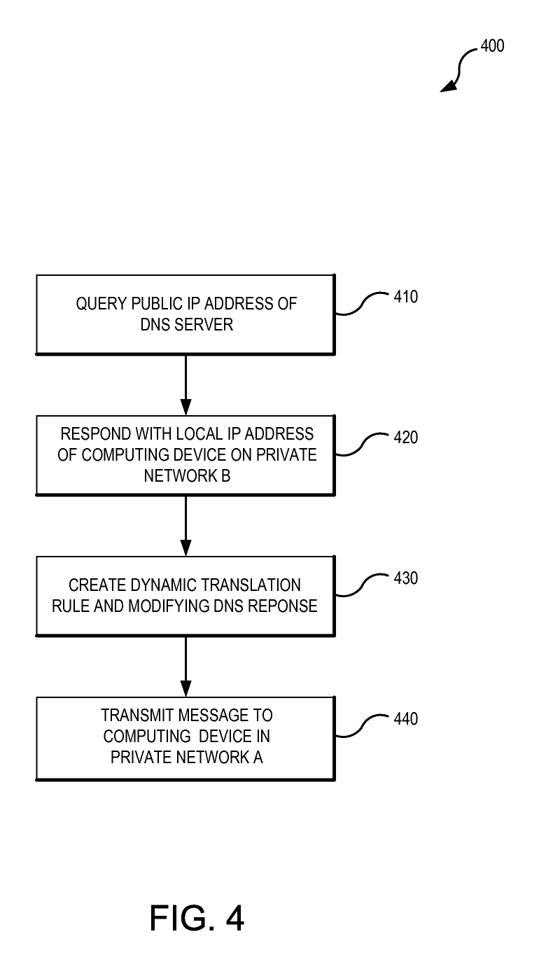

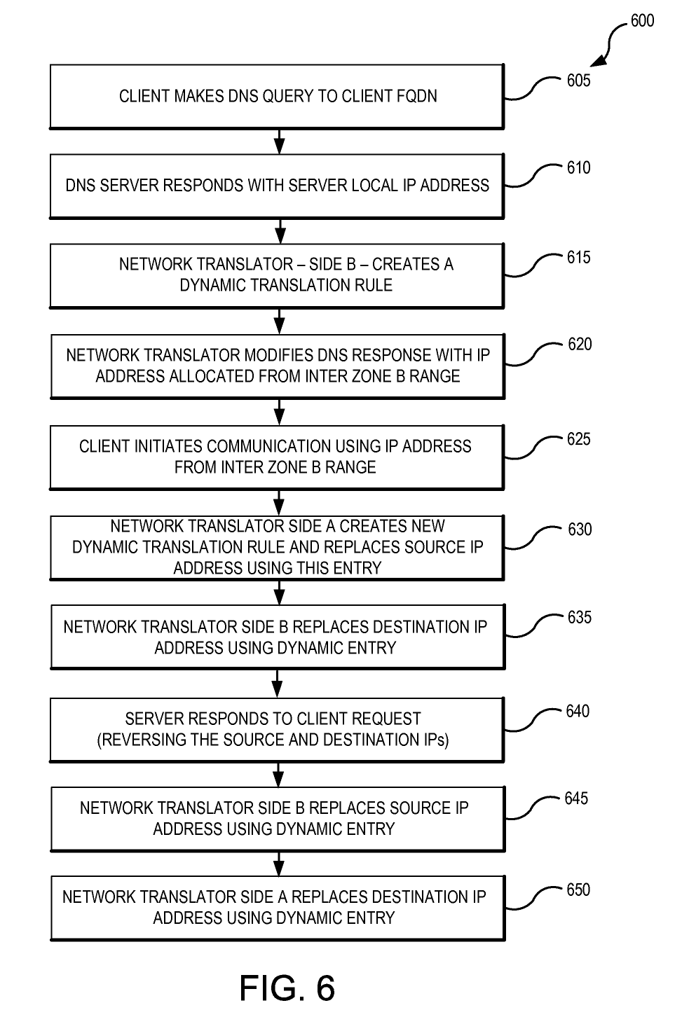

FIG. 4 is a high-level flowchart illustrating a basic set of operations 400 for routing messages in accordance with one or more embodiments of the present invention. FIG. 6 provides an example of a more detailed set of operations for routing messages. While the much of the functionality of FIG. 4 can be performed by the translation device, that functionality could be implemented in, or distributed across, various network components such as various computing devices, servers, routers, or other network components. These components are examples of some of the means for performing the operations illustrated in FIG. 4.

As illustrated in FIG. 4, during querying operation 410 a computing device on private network A queries the public IP address for a computing device (e.g., network server) in private network B. During response operation 420, a response is generated with the local IP address of a computing device on private network B. Translation operation 430 creates a dynamic translation rule and modifies the DNS response with a temporary IP address in the place of the private IP network address of the computing device on private network B. During transmission operation 440, the modified DNS response from the DNS server is transmitted to the computing device in private network A. Of course, the opposite steps are performed when a device in network B wishes to communicate with a device in network A.

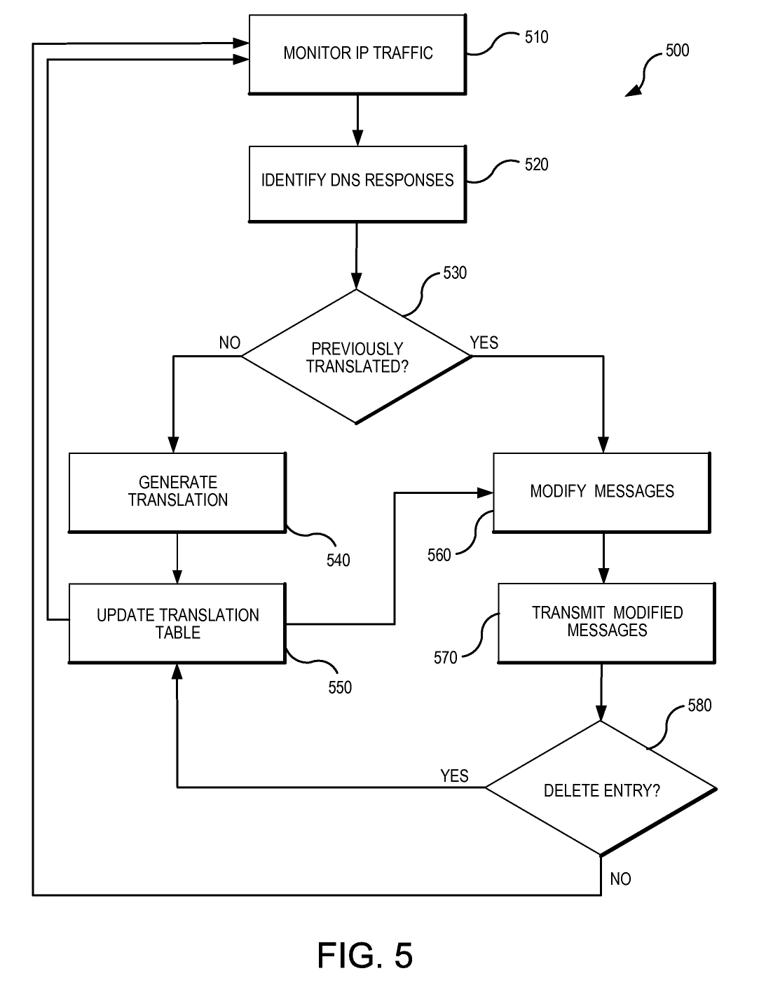

FIG. 5 is a flowchart illustrating a set of operations for operating a translation device in accordance with some embodiments of the present invention. The operations illustrated in FIG. 4 may be performed by translation device 230 or other component.

As illustrated in FIG. 5, monitoring operation 510 monitors IP traffic between two private networks having overlapping IP addresses that have been merged or that wish to enjoy cross-network communications. During identification operation 520, DNS server responses are identified and determination operation 530 determines whether the query has been previously translated. If determination operation 530 determines that a previous translation has not occurred, then determination operation 530 branches to translation operation 540 where a translation entry is created. Update operation 550 updates a translation table and modifies the response message with the temporary IP address during modification operation 560. If determination operation 530 determines that a previous translation has occurred, then determination operation 530 branches to modification operation 560 where the message is updated with the temporary IP address in the translation table.

The modified message is transmitted to the destination during transmission operation 570. Deletion operation 580 then determines if the translation table entry should be deleted. The determination to delete the translation table entry may be based on a variety of factors such as, but not limited to, maximum time, availability of computing devices, etc. If deletion operation 580 determines that the translation table entry should be deleted, then deletion operation 580 branches to update operation 550 where the translation table is updated before branching to monitoring operation 510. If deletion operation 580 determines that the translation table entry should not be deleted, then deletion operation 580 branches to monitoring operation 510 where IP traffic between two private networks is monitored.

FIG. 6 is a flowchart illustrating a set of operations 600 for routing a message in a networked environment in accordance with at least one embodiment of the present invention. During query operation 605, a client (e.g., at source IP 10.0.1.1) makes a query using FQDN to the remote DNS server (e.g., having public IP 198.51.100.1) asking for an IP address for a server or other computing device within private network B (e.g., S1.privatenetworkB.com which also has IP 10.0.0.1). The DNS server responds to side B of the translation device (e.g., using Dest IP 100.64.1.1:23456) during response operation 610 with the local IP address for the queried server or computing device (e.g., S1.privatenetworkB.com having IP address 10.0.0.1). Side B of the translation device creates a first dynamic translation rule by assigning an inter-zone IP address selected from an inter-zone IP address range associated with private network B during assignment operation 615. The selection may be based on a variety of criteria, formula, and/or standards such as, but not limited to, next in queue, random assignment, etc.

During modification operation 620, the DNS response is modified (i.e., a DNS fix-up) with an IP address allocated from inter-zone B range (e.g., 100.64.2.1:34567). The client in private network A can then initiate a communication during communication operation 625 with S1.privatenetworkB.com using the IP address from the inter-zone B IP range received from the DNS (i.e., 100.64.2.1:34567). Once received at the network translator—side A, translation operation 630 creates a new dynamic translation rule and replaces the source IP address with an IP address from an inter-zone A range of IP address and appropriately modifies a dynamic entry to a translation table for side A.

During modification operation 635, side B of the translation device replaces the destination IP address using the dynamic entry previously created and stored in the translation table for side B. The server or other computing device in network B responds to the client request during response operation 640 by reversing the source IP and the destination IP. Replacement operation 645 uses side B of the translation device to replace the source IP address using the dynamic entry previously created and stored in the translation table for side B. Side A of the translation device replaces the destination IP address using the dynamic entry previously created and stored in the translation table for side A during routing operation 650.

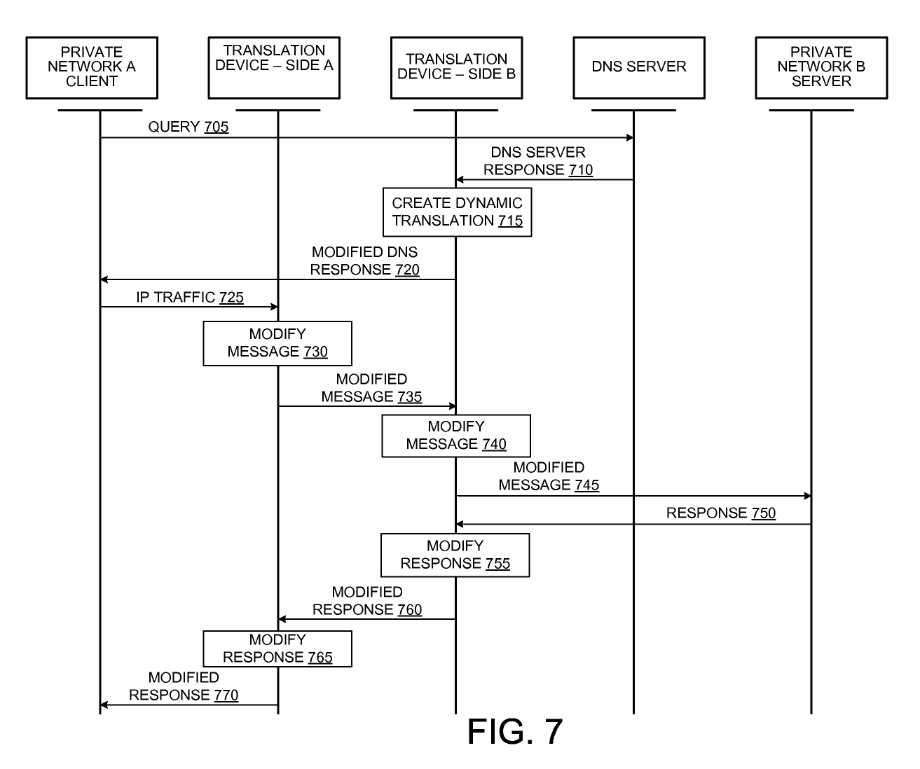

FIG. 7 is a sequence diagram illustrating communications between various components within a network similar those described in the operations of FIG. 6. As illustrated in FIG. 7, a client from private network A makes query 705 to the public IP address of a remote DNS server asking for an IP address of S1.privatenetworkB.com. The DNS server responds 710 with a local IP address for S1.privatenetworkB.com. The translation device receives the response from the DNS server and creates a dynamic translation rule 715. The translation device also modifies the DNS response (i.e., a DNS fix-up) with an IP address allocated from inter-zone B range, and provides that modified DNS response 720 to the network A client.

The network A client then initiates communication 725 with S1.privatenetworkB.com using the IP address from the inter-zone B IP range received from the DNS. The translation device—side A—modifies the message 730 by replacing the source IP address with an IP address from an inter-zone A range and adds a dynamic entry to the translation table. The translation device—side A—then sends 735 the modified message to the translation device—side B. In response, the translation device—side B—replaces 740 the destination IP address in the received message using the dynamic entry previously created, before passing the modified message 745 to the private network B server.

The server then sends a response 750 to the client request. The translation then performs a complementary operation to modify 755 the server's response. The translation device—side B—replaces 760 the source IP address using the previously created dynamic entry. Then, translation device—side A—replaces 765 the destination IP address using the dynamic entry previously created. Then the message 770 is forwarded to the client from private network A. A similar set of operations may be performed when a computing device from network B wants to communicate with network A. As a result, the translations on side A or side B of the translation device could be reversed or happy concurrently in some embodiments.

### Exemplary Computer System Overview

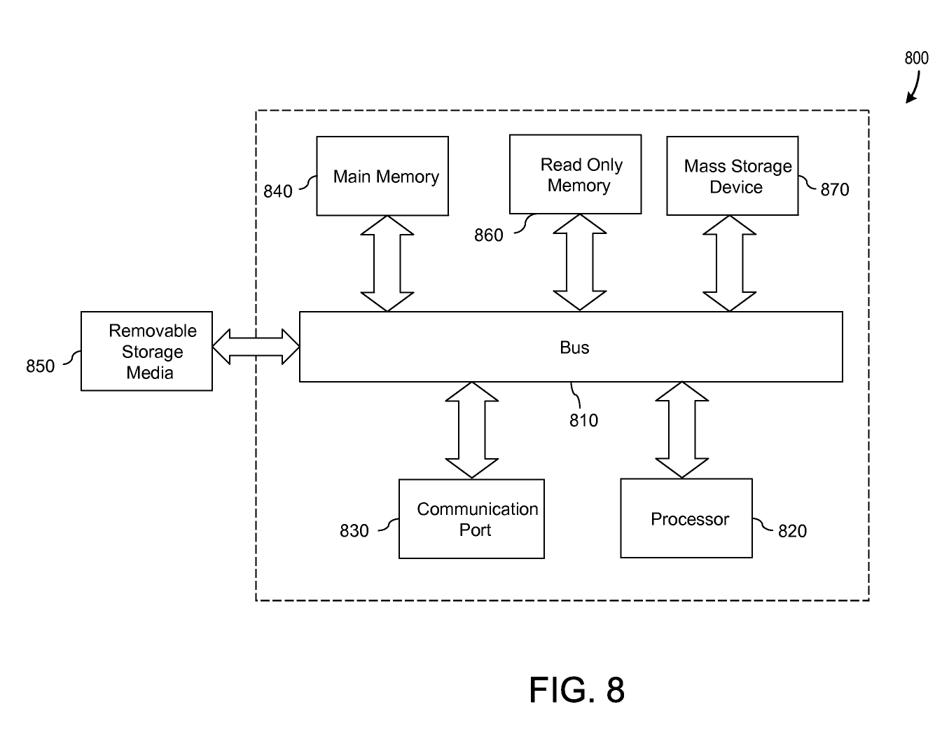

Embodiments of the present invention include various steps and operations, which have been described above. A variety of these steps and operations may be performed by hardware components or may be embodied in machine-executable instructions, which may be used to cause a general-purpose or special-purpose processor programmed with the instructions to perform these steps. Alternatively, the steps may be performed by a combination of hardware, software, and/or firmware. As such, FIG. 8 is an example of a computer system 800 with which embodiments of the present invention may be utilized. According to the present example, the computer system includes a bus 810, at least one processor 820, at least one communication port 830, a main memory 840, a removable storage media 850, a read only memory 860, and a mass storage 870.

Processor(s) 820 can be any known processor, such as, but not limited to, ARM or x86-type processors, such as an Intel® lines of processors; AMD® lines of processors processor(s); or Motorola® lines of processors. Communication port(s) 830 can be any of an RS-232 port for use with a modem-based dialup connection, a 10/100 Ethernet port, or a Gigabit port using copper or fiber. Communication port(s) 830 may be chosen depending on a network such as a Local Area Network (LAN), Wide Area Network (WAN), or any network to which the computer system 800 connects. The communication port 830 may also encompass wireless communications components, such as an IEEE 802.11, 3G/4G or other wireless transceiver.

Main memory 840 can be Random Access Memory (RAM) or any other dynamic storage device(s) commonly known in the art. Read only memory 860 can be any static storage device(s) such as Programmable Read Only Memory (PROM) chips for storing static information such as instructions for processor 820.

Mass storage 870 can be used to store information and instructions. For example, hard disks such as the Adaptec® family of SCSI drives, an optical disc, an array of disks such as RAID, such as the Adaptec family of RAID drives, or any other mass storage devices may be used.

Bus 810 communicatively couples processor(s) 820 with the other memory, storage and communication blocks. Bus 810 can be a PCI/PCI-X or SCSI based system bus depending on the storage devices used.

Removable storage media 850 can be any kind of external hard-drives, floppy drives, IOMEGA® Zip Drives, Compact Disc-Read Only Memory (CD-ROM), Compact Disc-Re-Writable (CD-RW), and/or Digital Video Disk-Read Only Memory (DVD-ROM).

The components described above are meant to exemplify some types of possibilities. In no way should the aforementioned examples limit the scope of the invention, as they are only exemplary embodiments.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements.

These and other changes can be made to the invention in light of the above Detailed Description. While the above description describes certain examples of the invention, and describes the best mode contemplated, no matter how detailed the above text appears, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

To reduce the number of claims, certain aspects of the invention are presented below in certain claim forms, but the applicant contemplates the various aspects of the invention in any number of claim forms. For example, while only one aspect of the invention is recited as a computer-readable medium claim, other aspects may likewise be embodied as a computer-readable medium claim, or in other forms, such as being embodied in a means-plus-function claim. (Any claims intended to be treated under 35 U.S.C. §112 (f) will begin with the words “means for”, but use of the term “for” in any other context is not intended to invoke treatment under 35 U.S.C. §112 (f).) Accordingly, the applicant reserves the right to pursue additional claims after filing this application to pursue such additional claim forms, in either this application or in a continuing application.

What is claimed is:

1. A method comprising:
creating, at a translation device, a first translation rule associating a first inter-zone IP address with a private IP address of a first computing device in a first private network,
wherein the first translation rule is generated after receiving a response from a DNS server to identify the private IP address of the first computing device;
modifying, at the translation device, the private IP address in the DNS response to the first inter-zone IP address;
creating, at the translation device, a second translation rule associating a source IP address of a second computing device in a second private network with a second inter-zone IP address selected from a second group of IP addresses assigned to the second private network;
modifying, at the translation device, the source IP address in a message from the second computing device to the second inter-zone IP address and a destination IP address in the message with the first inter-zone IP address; and
transmitting the message to the first computing device in the first private network.

2. The method of claim 1, wherein the first private network and the second private network have at least two computing devices each assigned to the same private IP address.

3. The method of claim 1, further comprising:
receiving, at the translation device, the response from the DNS query that includes the private IP address of the first computing device in the first private network; and
selecting, at the translation device, the first inter-zone IP address from a first group of inter-zone IP addresses assigned to the first private network.

4. The method of claim 1, further comprising receiving, from the second computing device having the source IP address in the second private network, the message directed to the first inter-zone IP address.

5. The method of claim 1, further comprising selecting, at the translation device, the second inter-zone IP address from a second group of inter-zone IP addresses assigned to the second private network.

6. The method of claim 1, wherein the translation device has two different IP addresses.

7. The method of claim 1, wherein upon receiving a response from the first computing device in the first private network, the method further comprises:
replacing a source IP address in the response with the first inter-zone IP address; and
replacing a destination IP address in the response using the second translation rule.

8. The method of claim 1, further comprising:
storing the first translation rule in a first translation table; and
storing the second translation rule in a second translation table.

9. A translation device for interconnecting overlapping IP networks, the translation device comprising:
a processor;
at least one communications interface to receive IP messages from the overlapping IP networks;
wherein the overlapping IP networks include at least one IP address associated with two different computing devices;
at least one translation module, running on the processor, to monitor DNS server responses and generate a first translation in response to detected DNS server responses to queries asking for IP addresses of a first computing device,
wherein the translation module also generates a second translation in response messages sent from a second computing device to the first computing device; and
a modification module, running on the processor, to modify the IP messages before transmission to a next destination.

10. The translation device of claim 9, wherein the communications interface includes two separately addressable sides.

11. The translation device of claim 9, wherein the translation module stores the first translation and the second translation in a translation table.

12. The translation device of claim 11, wherein the modification module removes the first translation and the second translation from the translation table.

13. The translation device of claim 11, wherein the modification module removes the first translation and the second translation from the translation table upon determining that the first computing device or the second computing device is not available.

14. The translation device of claim 11, wherein the modification module removes the first translation and the second translation from the translation table after a fixed period of time.

15. The translation device of claim 9, wherein the translation module selects inter-zone IP addresses for the first translation and the second translation.

16. A computer-readable medium, excluding transitory propagating signals, and storing instructions that when executed by one or more processors cause the one or more processors to:
receive a response from a DNS query that includes a private IP address of a destination computing device in a destination private network;
select a destination inter-zone IP address from a group of IP addresses assigned to the destination private network;
modify the private IP address in the DNS response to the destination inter-zone IP address;
receive, from a source computing device having a source address in a source private network, a message directed to the source inter-zone IP address; and
modify the source address in the message to the source inter-zone IP address and a destination IP address with the destination inter-zone IP address.

17. The computer-readable medium of claim 16, wherein the instructions when executed by the one or more processors further cause the one or more processors to:
create a first translation rule associating the destination inter-zone IP address with the private IP address of the destination computing device in the destination private network;
store the first translation rule in a first translation table;
create a second translation rule associating the source IP address of the source computing device with a source inter-zone IP address selected from a second group of IP addresses assigned to the source private network; and
store the second translation rule in a second translation table.

18. The computer-readable medium of claim 16, wherein the instructions when executed by the one or more processors further cause the one or more processors to remove the first translation rule from the first translation table and the second translation rule from the second translation table.

19. The computer-readable medium of claim 18, wherein the first translation rule and the second translation rule are removed after a fixed period of time or upon determining that the destination computing device or the source computing device is unavailable.

20. The computer-readable medium of claim 19, wherein the response from the DNS query is addressed to a first side of a translation device.
